(19) United States
(12) Patent Application Publication
(10) Pub. No.: US 2016/0275900 A1
(43) Pub. Date: Sep. 22, 2016

(54) ADAPTIVE PARTIAL SCREEN UPDATE WITH DYNAMIC BACKLIGHT CONTROL CAPABILITY

(71) Applicants: Seh W. Kwa, Saratoga, CA (US); Satyanarayana Avadhanam, El Dorado Hills, CA (US); Ravi Ranganathan, Sunnyvale, CA (US)

(72) Inventors: Seh W. Kwa, Saratoga, CA (US); Satyanarayana Avadhanam, El Dorado Hills, CA (US); Ravi Ranganathan, Sunnyvale, CA (US)

(21) Appl. No.: 14/371,385

(22) PCT Filed: Dec. 28, 2013
(86) PCT No.: PCT/US2013/078151

§ 371 Date: Jul. 9, 2014

(51) Int. Cl. G09G 5/00; G06F 13/42; G06F 1/32

(52) U.S. Cl. CPC G09G 5/003; G06F 1/3265; G06F 13/4282; G09G 2320/0626; G09G 2330/021

(57) ABSTRACT

Methods and apparatus relating to adaptive partial screen update with dynamic backlight control capability are described. In an embodiment, logic causes retrieval of a full frame of content (to be displayed on a display device) based at least in part on an amount of partial screen change to be performed. Other embodiments are also disclosed and claimed.

### FIELD

The present disclosure generally relates to the field of electronics. More particularly, an embodiment relates to adaptive partial screen update with dynamic backlight control capability.

### BACKGROUND

Portable computing devices are gaining popularity, in part, because of their decreasing prices and increasing performance. Another reason for their increasing popularity may be due to the fact that some portable computing devices may be operated at many locations, e.g., by relying on battery power. However, as more functionality is integrated into portable computing devices, the need to reduce power consumption becomes increasingly important, for example, to maintain battery power for an extended period of time.

Moreover, some portable computing devices include a Liquid Crystal Display (LCD) or “flat panel” display. Today's mobile devices are generally designed to be “always ready” for updating new frames on the display. While this state of readiness may be great for visual performance requirements, the levels of power consumption incurred becomes wasteful when the system is idle or otherwise not in use (e.g., while the image on the display does not change for a given time period).

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 3-4 illustrate block diagrams of embodiments of computing systems, which may be utilized to implement various embodiments discussed herein.

FIG. 2 illustrates a flow diagram in accordance with an embodiment.

FIG. 5 illustrates a block diagram of an SOC (System On Chip) package in accordance with an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

PSR2 (Second Generation/Gen2 Panel Self Refresh) is a technology meant to update only portion(s) of the screen that change. This is also known as selective update. As part of the power optimization, it is deemed beneficial to fetch from system memory only the portion(s) of screen content that change to reduce memory bandwidth and/or increase memory residency in self refresh state (i.e., to reduce power consumption). However, a related display power reduction technology DPST (Display Power Saving Technology) requires characterization of the whole frame content in order to make policy decisions regarding tuning of the pixel content to a lighter shade and corresponding backlight reduction to achieve desired power reduction, while minimizing any apparent visual distortion. Hence, the concurrency and coexistence of these two technologies (i.e., PSR2 and DPST) present conflicts.

To this end, some embodiments provide adaptive partial screen update with dynamic backlight control capability. In an embodiment, heuristic awareness is used for selective update (or PSR2) to determine the amount of change and/or the frequency of change to a screen (also referred to herein interchangeably as a display, a panel, a display panel, etc.) in order to co-ordinate with DPST more intelligently. For example, infrequent and/or minor changes are aligned/ordered together in order to minimize system memory traffic and/or afford longer duration of low power state residency for hardware, such as a processor or a System On Chip (SOC) devices.

Moreover, some embodiments allow for PSR2 and DPST to coexist and also enhance DPST with PSR2 concurrency versus a different system configuration where PSR2 is available to reduce system memory traffic and associated power impact on SOC/processor, while DPST alternatives (such as CABC (Content Adaptive Brightness Control), e.g., integrated in the panel) remain functional to reduce backlight and display panel power consumption.

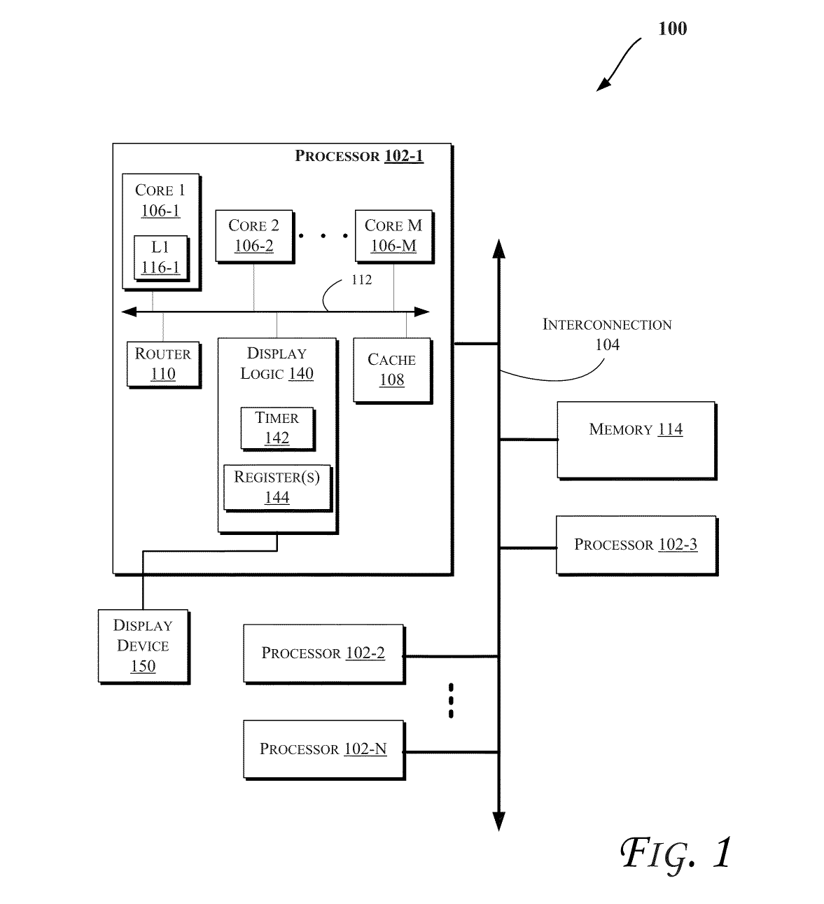

Some embodiments may be applied in computing systems that include one or more processors (e.g., with one or more processor cores), such as those discussed with reference to FIGS. 1-5, including for example mobile computing devices such as a smartphone, tablet, UMPC (Ultra-Mobile Personal Computer), laptop computer, Ultrabook™ computing device, smart watch, smart glasses, wearable devices, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may be general-purpose CPUs (Central Processing Units) and/or GPUs (Graphics Processing Units) in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

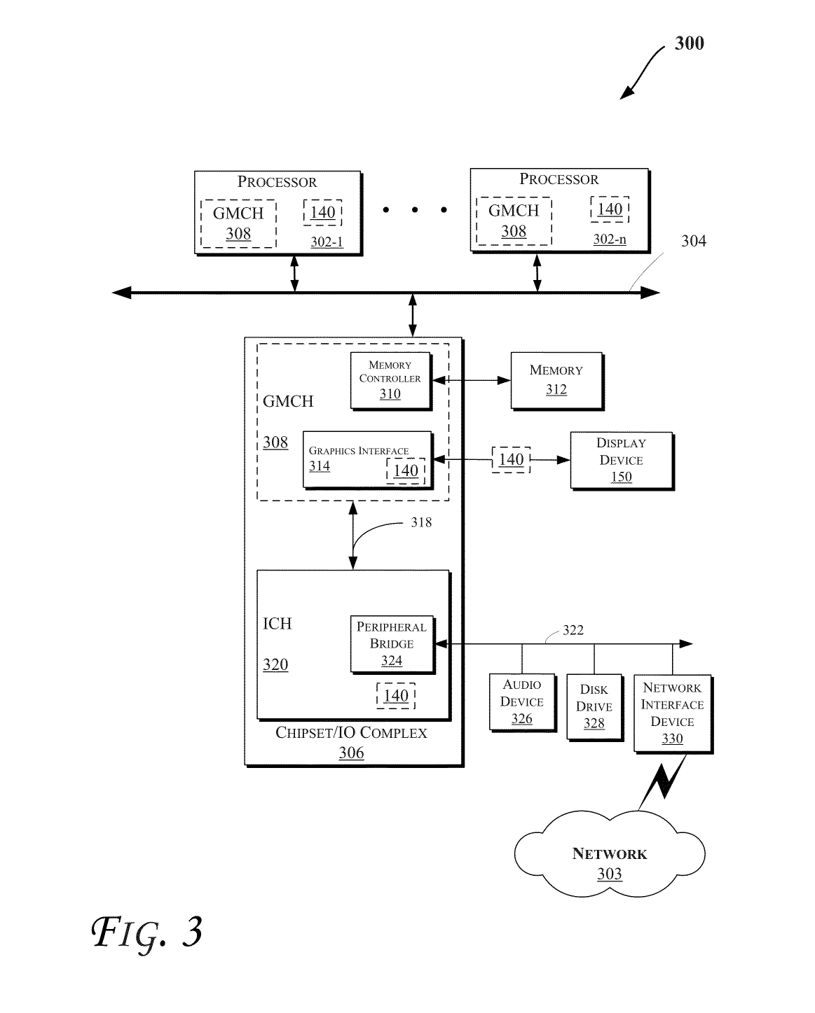

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 3-5), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

As shown in FIG. 1, the processor 102 may further include display logic 140 to control various aspects of operations for a display device 150. In various embodiments, the display device 150 may be a flat display panel such as a Liquid Crystal Display (LCD) having a backlight source, via Light Emitting Diodes (LEDs) for example. Also, display device 150 may be a plasma display or a field emission display. Logic 140 may have access to one or more storage devices discussed herein (such as cache 108, L1 cache 116, memory 114, register(s) 144, or another memory in system 100) to store information relating to operations of the logic 140 and display device 150, such as information communicated with various components of system 100 as discussed here.

In some embodiments, one or more of the following tracking parameters are used by logic 140: (1) a DPST concurrency timer 142 that is used to count down from the maximum number of frames to wait prior to a full frame fetch/retrieval for DPST to perform its function; (2) a percentage screen change threshold parameter/value (e.g., stored in one of registers 144 or other memory/storage device discussed herein) that is used to trigger a full frame update whenever screen change is above this threshold value; and/or (3) a maximum number of partial frame updates threshold parameter/value (e.g., stored in one of registers 144 or other memory/storage device discussed herein) which can be set so that a full frame update is triggered to allow for DPST to perform its function when the number of partial update frames is equal or greater than this maximum threshold value. Also, even though logic 140 (and its components) are shown inside a processor, one or more of these components may be provided elsewhere in the system (such as coupled to interconnection 104, within processor cores 106, within display device 150, etc.).

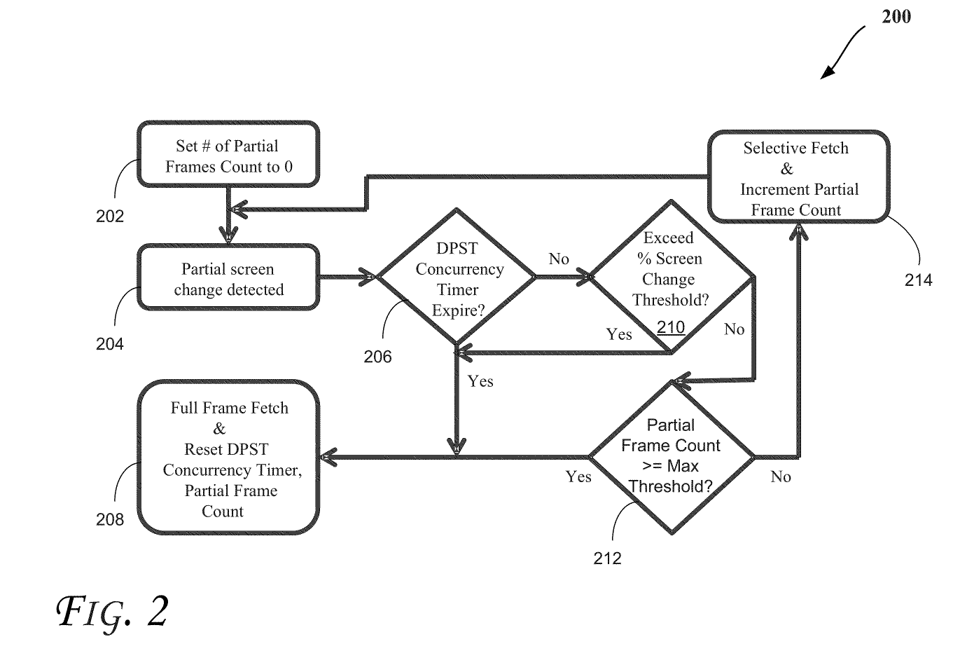

FIG. 2 illustrates a flow diagram of a method 200 for tracking coexistence of PSR2 and DPST concurrency, according to an embodiment. One or more components discussed herein (e.g., with reference to FIGS. 1 and 3-5) may be used to perform one or more operations discussed with reference to FIG. 2. For example, operations 202-214 may be performed by logic 140 (and its components such as timer 142) and values or counts discussed may be stored in register(s) 144 or other type of memory/storage discussed herein.

Referring to FIGS. 1-2, at an operation 202, the number of partial frame count is initialized (e.g., to 0). At an operation 204, partial screen change is detected (e.g., by logic 140 based on the frame information received for display on the display device 150). Once DPST concurrency timer (e.g., timer 142) expires at operation 206, a full frame of content is fetched/retrieved (e.g., caused by logic 140) and DPST timer and number of frame count are reset at operation 208 (e.g., by logic 140). However, as long as the DPST timer is not expired (as determined at operation 206), operation 210 determines whether the percentage screen change threshold value has been exceeded. If so, method 200 resumes with operation 208; otherwise, operation 212 determines whether the partial update frame count has exceeded the maximum number of partial update frames threshold value. If the maximum number of partial frame updates is exceeded, method 200 resumes at operation 208; otherwise, operation 214 performs selective fetch and the partial update frame count is incremented, and subsequently method 200 resumes at operation 204.

Accordingly, in an embodiment, whenever the screen change exceeds the percentage screen change threshold, the DPST concurrency timer expires, or the number of partial update frames reaches the maximum allowed, a full frame content is fetched from system memory for DPST to adjust the pixel content in a full frame update and backlight brightness. Moreover, delaying a full frame update for DPST to perform its function (e.g., by as much as 20-30 frames) may be visually equivalent under multiple workloads such as Internet-based video streaming (full screen and partial screen), video playback, and office productivity.

FIG. 3 illustrates a block diagram of a computing system 300 in accordance with an embodiment. The computing system 300 may include one or more Central Processing Units (CPUs) 302 or processors that communicate via an interconnection network (or bus) 304. The processors 302 may include a general purpose processor, a network processor (that processes data communicated over a computer network 303), or other types of a processor (including a reduced instruction set computer (RISC) processor or a complex instruction set computer (CISC)).

Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors. In an embodiment, one or more of the processors 302 may be the same or similar to the processors 102 of FIG. 1. For example, one or more components of system 300 may include logic 140 discussed with reference to FIGS. 1-2 (including but not limited to those illustrated in FIG. 3). Also, the operations discussed with reference to FIGS. 1-2 may be performed by one or more components of the system 300.

A chipset 306 may also communicate with the interconnection network 304. The chipset 306 may include a graphics memory control hub (GMCH) 308, which may be located in various components of system 300 (such as those shown in FIG. 3). The GMCH 308 may include a memory controller 310 that communicates with a memory 312 (which may be the same or similar to the memory 114 of FIG. 1). The memory 312 may store data, including sequences of instructions, that may be executed by the CPU 302, or any other device included in the computing system 300. In one embodiment, the memory 312 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 304, such as multiple CPUs and/or multiple system memories.

The GMCH 308 may also include a graphics interface 314 that communicates with the display device 150. In one embodiment, the graphics interface 314 may communicate with the display device 150 via an accelerated graphics port (AGP) or Peripheral Component Interconnect (PCI) (or PCI express (PCIe) interface). In an embodiment, the display 150 (such as a flat panel display) may communicate with the graphics interface 314 through, for example, a signal converter that translates a digital representation of an image stored in a storage device such as video memory or system memory into display signals that are interpreted and displayed by the display 150. The display signals produced by the display device may pass through various control devices (e.g., logic 140) before being interpreted by and subsequently displayed on the display 150.

A hub interface 318 may allow the GMCH 308 and an input/output control hub (ICH) 320 to communicate. The ICH 320 may provide an interface to I/O device(s) that communicate with the computing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the CPU 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with an audio device 326, one or more disk drive(s) 328, and a network interface device 330 (which is in communication with the computer network 303). Other devices may communicate via the bus 322. Also, various components (such as the network interface device 330) may communicate with the GMCH 308 in some embodiments. In addition, the processor 302 and the GMCH 308 may be combined to form a single chip. Furthermore, a graphics accelerator may be included within the GMCH 308 in other embodiments.

Furthermore, the computing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

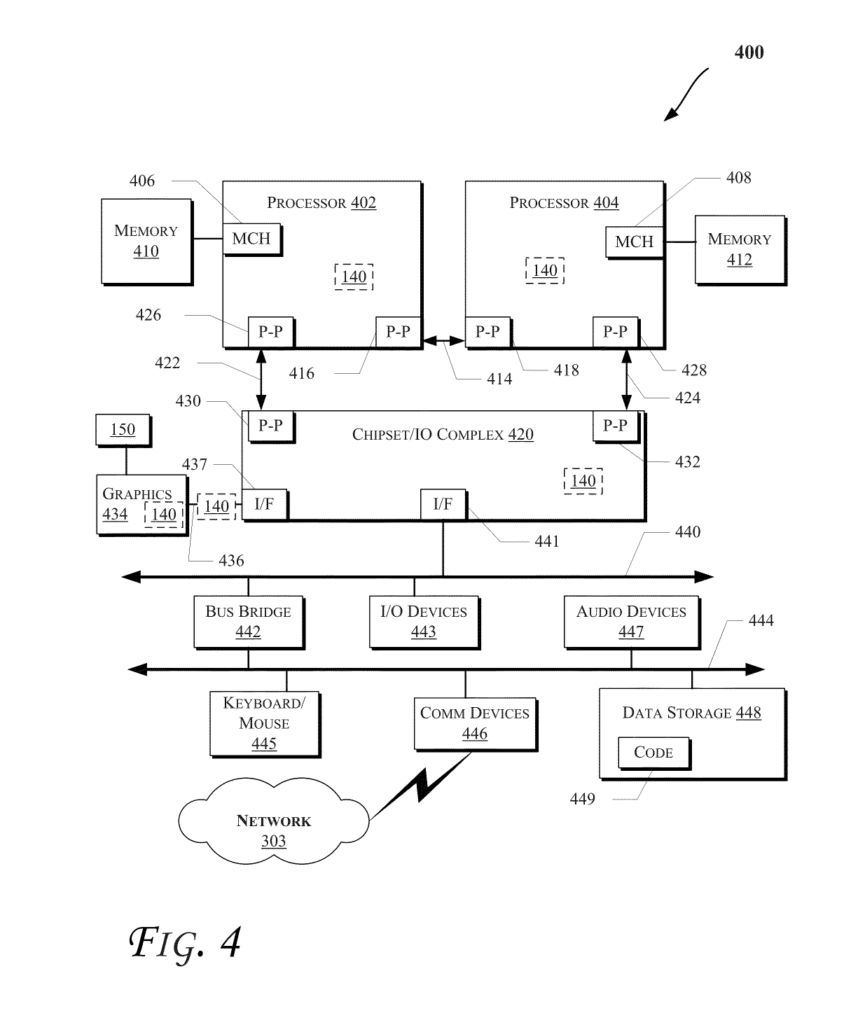

FIG. 4 illustrates a computing system 400 that is arranged in a point-to-point (PtP) configuration, according to an embodiment. In particular, FIG. 4 shows a system where processors, memory, and input/output devices are interconnected by a number of point-to-point interfaces. The operations discussed with reference to FIGS. 1-3 may be performed by one or more components of the system 400.

As illustrated in FIG. 4, the system 400 may include several processors, of which only two, processors 402 and 404 are shown for clarity. The processors 402 and 404 may each include a local memory controller hub (MCH) 406 and 408 to enable communication with memories 410 and 412. The memories 410 and/or 412 may store various data such as those discussed with reference to the memory 312 of FIG. 3.

In an embodiment, the processors 402 and 404 may be one of the processors 302 discussed with reference to FIG. 3. The processors 402 and 404 may exchange data via a point-to-point (PtP) interface 414 using PtP interface circuits 416 and 418, respectively. Also, the processors 402 and 404 may each exchange data with a chipset 420 via individual PtP interfaces 422 and 424 using point-to-point interface circuits 426, 428, 430, and 432. The chipset 420 may further exchange data with a graphics circuit 434 via a graphics interface 436, e.g., using a PtP interface circuit 437.

At least one embodiment may be provided within the processors 402 and 404. For example, one or more components of system 400 may include logic 140 discussed with reference to FIGS. 1-3 (including but not limited to those illustrated in FIG. 4). Other embodiments, however, may exist in other circuits, logic units, or devices within the system 400 of FIG. 4. Furthermore, other embodiments may be distributed throughout several circuits, logic units, or devices illustrated in FIG. 4.

The chipset 420 may communicate with a bus 440 using a PtP interface circuit 441. The bus 440 may communicate with one or more devices, such as a bus bridge 442 and I/O devices 443. Via a bus 444, the bus bridge 442 may communicate with other devices such as a keyboard/mouse 445, communication devices 446 (such as modems, network interface devices, or other communication devices that may communicate with the computer network 303), audio I/O device 447, and/or a data storage device 448. The data storage device 448 may store code 449 that may be executed by the processors 402 and/or 404.

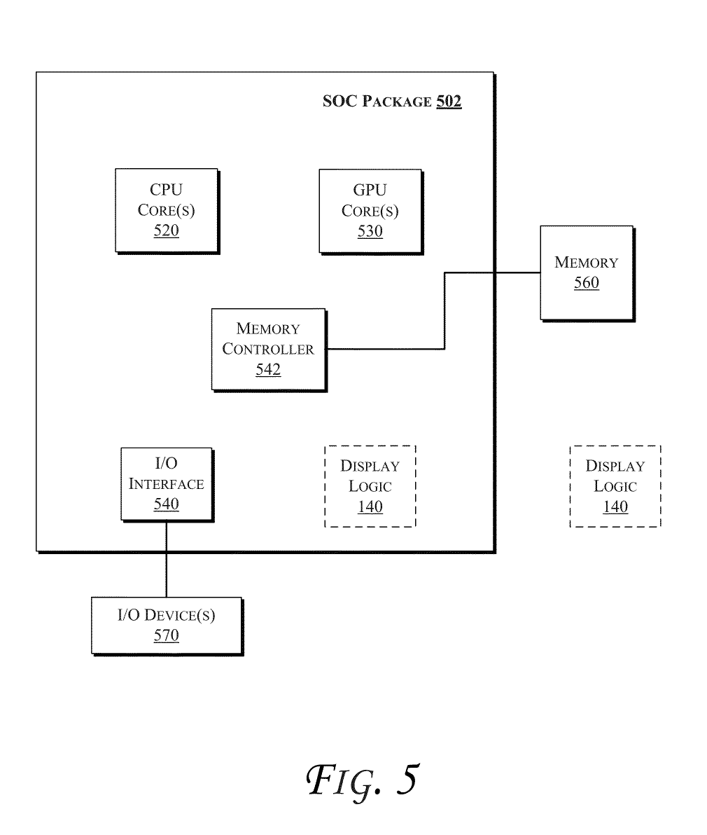

In some embodiments, one or more of the components discussed herein can be embodied as a System On Chip (SOC) device. FIG. 5 illustrates a block diagram of an SOC package in accordance with an embodiment. As illustrated in FIG. 5, SOC 502 includes one or more Central Processing Unit (CPU) cores 520, one or more Graphics Processing Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 520 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 (which may be similar to or the same as memory discussed herein with reference to the other figures) via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display device, an image/video capture device (such as a camera or camcorder/video recorder), a touch screen, a speaker, or the like. Furthermore, SOC package 502 may include/integrate logic 140 in an embodiment. Alternatively, logic 140 may be provided outside of the SOC package 502 (i.e., as a discrete logic).

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 3 and/or 4, including for example a flat panel display device, etc.).

The following examples pertain to further embodiments. Example 1 includes an apparatus comprising: logic, the logic at least partially comprising hardware logic, to cause retrieval of a full frame of content, to be displayed on a display device, based at least in part on an amount of partial screen change to be performed. Example 2 includes the apparatus of example 1, wherein the logic is to cause retrieval of the full frame of content based at least in part on an amount of time since a last retrieval of the full frame of content. Example 3 includes the apparatus of example 1, wherein the logic is to cause retrieval of the full frame of content in response to expiration of a timer. Example 4 includes the apparatus of example 3, wherein the timer is to correspond to a display power reduction operation that is capable of reducing power consumption by a backlight of the display device. Example 5 includes the apparatus of example 3, wherein the logic is to cause resetting of the timer in response to the retrieval of the full frame of content. Example 6 includes the apparatus of example 1, wherein the logic is to cause retrieval of the full frame of content based at least in part on a number of partial frame updates that have been performed. Example 7 includes the apparatus of example 1, wherein the logic is to cause retrieval of the full frame of content in response to comparison of a partial frame count and a partial frame count threshold value. Example 8 includes the apparatus of example 7, wherein the partial frame count is to be updated in response to the partial frame count not exceeding the partial frame count threshold value. Example 9 includes the apparatus of example 7, wherein the logic is to cause resetting of the partial frame count in response to the retrieval of the full frame of content. Example 10 includes the apparatus of example 1, wherein the logic is to cause retrieval of the full frame of content, to be displayed on the display device, in response to comparison of a detected partial screen change value and a screen change threshold value. Example 11 includes the apparatus of example 1, wherein the display device is to comprise a liquid crystal display, a plasma display, or a field emission display. Example 12 includes the apparatus of example 1, wherein a processor, having one or more processor cores, is to comprise the logic. Example 13 includes the apparatus of example 1, wherein one or more of the logic, a processor having one or more processor cores, and memory are on a single integrated circuit die.

Example 14 includes a method comprising: causing retrieval of a full frame of content, to be displayed on a display device, based at least in part on an amount of partial screen change to be performed. Example 15 includes the method of example 14, further comprising causing retrieval of the full frame of content based at least in part on an amount of time since a last retrieval of the full frame of content. Example 16 includes the method of example 14, further comprising causing retrieval of the full frame of content in response to expiration of a timer. Example 17 includes the method of example 16, wherein the timer corresponds to a display power reduction operation that is capable of reducing power consumption by a backlight of the display device. Example 18 includes the method of example 16, further comprising causing resetting of the timer in response to the retrieval of the full frame of content. Example 19 includes the method of example 14, further comprising causing retrieval of the full frame of content based at least in part on a number of partial frame updates that have been performed. Example 20 includes the method of example 14, further comprising causing retrieval of the full frame of content in response to comparison of a partial frame count and a partial frame count threshold value. Example 21 includes the method of example 20, further comprising updating the partial frame count in response to the partial frame count not exceeding the partial frame count threshold value. Example 22 includes the method of example 20, further comprising resetting the partial frame count in response to the retrieval of the full frame of content. Example 23 includes the method of example 14, further comprising causing retrieval of the full frame of content, to be displayed on the display device, in response to comparison of a detected partial screen change value and a screen change threshold value.

Example 24 includes a computer-readable medium comprising one or more instructions that when executed on a processor configure the processor to perform one or more operations of any of examples 14 to 23.

Example 25 includes an apparatus comprising means to perform a method as set forth in any of examples 14 to 23.

Example 26 includes a system comprising: memory to store at least one full frame of content; a display device; and logic, the logic at least partially comprising hardware logic, to cause retrieval of the full frame of content, to be displayed on the display device, based at least in part on an amount of partial screen change to be performed. Example 27 includes the system of example 26, wherein the logic is to cause retrieval of the full frame of content based at least in part on an amount of time since a last retrieval of the full frame of content. Example 28 includes the system of example 26, wherein the logic is to cause retrieval of the full frame of content in response to expiration of a timer. Example 29 includes the system of example 28, wherein the timer is to correspond to a display power reduction operation that is capable of reducing power consumption by a backlight of the display device. Example 30 includes the system of example 28, wherein the logic is to cause resetting of the timer in response to the retrieval of the full frame of content. Example 31 includes the system of example 26, wherein the logic is to cause retrieval of the full frame of content based at least in part on a number of partial frame updates that have been performed. Example 32 includes the system of example 26, wherein the logic is to cause retrieval of the full frame of content in response to comparison of a partial frame count and a partial frame count threshold value. Example 33 includes the system of example 32, wherein the partial frame count is to be updated in response to the partial frame count not exceeding the partial frame count threshold value. Example 34 includes the system of example 32, wherein the logic is to cause resetting of the partial frame count in response to the retrieval of the full frame of content. Example 35 includes the system of example 26, wherein the logic is to cause retrieval of the full frame of content, to be displayed on the display device, in response to comparison of a detected partial screen change value and a screen change threshold value. Example 36 includes the system of example 26, wherein the display device is to comprise a liquid crystal display, a plasma display, or a field emission display. Example 37 includes the system of example 26, wherein a processor, having one or more processor cores, is to comprise the logic. Example 38 includes the system of example 26, wherein one or more of the logic, a processor having one or more processor cores, and memory are on a single integrated circuit die.

Example 39 includes an apparatus comprising means to perform a method as set forth in any preceding example.

Example 40 includes machine-readable storage including machine-readable instructions, when executed, to implement a method or realize an apparatus as claimed in any preceding claim.

In various embodiments, the operations discussed herein, e.g., with reference to FIGS. 1-5, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1.-25. (canceled)

26. An apparatus comprising:
logic, the logic at least partially comprising hardware logic, to cause retrieval of a full frame of content, to be displayed on a display device, based at least in part on an amount of partial screen change to be performed.

27. The apparatus of claim 26, wherein the logic is to cause retrieval of the full frame of content based at least in part on an amount of time since a last retrieval of the full frame of content.

28. The apparatus of claim 26, wherein the logic is to cause retrieval of the full frame of content in response to expiration of a timer.

29. The apparatus of claim 28, wherein the timer is to correspond to a display power reduction operation that is capable of reducing power consumption by a backlight of the display device.

30. The apparatus of claim 28, wherein the logic is to cause resetting of the timer in response to the retrieval of the full frame of content.

31. The apparatus of claim 26, wherein the logic is to cause retrieval of the full frame of content based at least in part on a number of partial frame updates that have been performed.

32. The apparatus of claim 26, wherein the logic is to cause retrieval of the full frame of content in response to comparison of a partial frame count and a partial frame count threshold value.

33. The apparatus of claim 32, wherein the partial frame count is to be updated in response to the partial frame count not exceeding the partial frame count threshold value.

34. The apparatus of claim 32, wherein the logic is to cause resetting of the partial frame count in response to the retrieval of the full frame of content.

35. The apparatus of claim 26, wherein the logic is to cause retrieval of the full frame of content, to be displayed on the display device, in response to comparison of a detected partial screen change value and a screen change threshold value.

36. The apparatus of claim 26, wherein the display device is to comprise a liquid crystal display, a plasma display, or a field emission display.

37. The apparatus of claim 26, wherein a processor, having one or more processor cores, is to comprise the logic.

38. The apparatus of claim 26, wherein one or more of the logic, a processor having one or more processor cores, and memory are on a single integrated circuit die.

39. A computer-readable medium comprising one or more instructions that when executed on a processor configure the processor to perform one or more operations to:
cause retrieval of a full frame of content, to be displayed on a display device, based at least in part on an amount of partial screen change to be performed.

40. The computer-readable medium of claim 39, further comprising one or more instructions that when executed on the processor configure the processor to perform one or more operations to cause retrieval of the full frame of content based at least in part on an amount of time since a last retrieval of the full frame of content.

41. The computer-readable medium of claim 39, further comprising one or more instructions that when executed on the processor configure the processor to perform one or more operations to cause retrieval of the full frame of content in response to expiration of a timer.

42. The computer-readable medium of claim 39, further comprising one or more instructions that when executed on the processor configure the processor to perform one or more operations to cause retrieval of the full frame of content based at least in part on a number of partial frame updates that have been performed.

43. The computer-readable medium of claim 39, further comprising one or more instructions that when executed on the processor configure the processor to perform one or more operations to cause retrieval of the full frame of content in response to comparison of a partial frame count and a partial frame count threshold value.

44. The computer-readable medium of claim 39, further comprising one or more instructions that when executed on the processor configure the processor to perform one or more operations to cause retrieval of the full frame of content, to be displayed on the display device, in response to comparison of a detected partial screen change value and a screen change threshold value.

45. A system comprising:
memory to store at least one full frame of content;
a display device; and
logic, the logic at least partially comprising hardware logic, to cause retrieval of the full frame of content, to be displayed on the display device, based at least in part on an amount of partial screen change to be performed.

46. The system of claim 45, wherein the logic is to cause retrieval of the full frame of content based at least in part on an amount of time since a last retrieval of the full frame of content.

47. The system of claim 45, wherein the logic is to cause retrieval of the full frame of content in response to expiration of a timer.

48. A method comprising:
causing retrieval of a full frame of content, to be displayed on a display device, based at least in part on an amount of partial screen change to be performed.

49. The method of claim 48, further comprising causing retrieval of the full frame of content based at least in part on an amount of time since a last retrieval of the full frame of content.

50. The method of claim 48, further comprising causing retrieval of the full frame of content in response to expiration of a timer.
